(19) United States
(12) Patent Application Publication
(10) Pub. No.: US 2024/0233061 A9
(43) Pub. Date: Jul. 11, 2024

(54) METHOD AND APPARATUS FOR 6DOF OBJECT POSE ESTIMATION USING SELF-SUPERVISION LEARNING

(71) Applicants: SEOUL NATIONAL UNIVERSITY HOSPITAL, Seoul (KR); Electronics and Telecommunications Research Institute, Daejeon (KR)

(72) Inventors: Eun Ju JEONG, Daejeon (KR); Young Gon KIM, Seoul (KR); Ju Seong JIN, Seoul (KR); Dae Youn KIM, Seoul (KR); Seung Jae CHOI, Seoul (KR)

(21) Appl. No.: 18/491,051

(22) Filed: Oct. 20, 2023

(30) Foreign Application Priority Data
Oct. 21, 2022 (KR) 10-2022-0136519
Oct. 18, 2023 (KR) 10-2023-0139452

(51) Int. Cl. G06T 1/00; G06T 7/50; G06T 7/70

(52) U.S. Cl. CPC G06T 1/0014; G06T 7/50; G06T 7/70; G06T 2207/20081

(57) ABSTRACT

Provided are a device and method for estimating a pose of an object. The method includes inputting a labeled source image and an unlabeled target image to a recognition model for generating training data, training the recognition model to generate object information of the unlabeled target image, determining the generated object information to be a pseudo label of the unlabeled target image, and training a pose estimation model for estimating a pose of an object by inputting the pseudo-labeled target image and the labeled source image to the pose estimation model.

### CROSS-REFERENCE TO RELATED APPLICATIONS

This application claims priority to and the benefit of Korean Patent Application No. 10-2022-0136519, filed on Oct. 21, 2022 and Korean Patent Application No. 10-2023-0139452, filed on Oct. 18, 2023, which are hereby incorporated by reference for all purposes as if set forth herein.

### BACKGROUND

### 1. Field of the Invention

The present invention relates to a technology for estimating a six degrees of freedom (6DoF) pose of an object on the basis of self-supervised learning.

### 2. Description of Related Art

Industrial robots are widely used in major national key industries, such as automobiles, heavy industry, semiconductors, displays, and the like, to secure alternative labor, increase productivity, and improve industrial competitiveness.

Main factors that reduce the accuracy of industrial robots are geometric errors, thermal induced errors, dynamic errors, and the like. These errors result in location and angle errors in space, that is, multi-degrees of freedom (DoF) errors representing six DoF (6DoF).

To measure multi-DoF errors, laser interferometers are widely used, but the number of measurable errors is limited. Also, an offline method of measuring an error in advance and correcting the error in a transfer process is mainly used. Therefore, a laser interferometer may be used for increasing accuracy on the basis of a technology for evaluating and correcting geometric errors which are static errors, but it is difficult to apply it in order to increase accuracy degraded by time-variant errors such as a thermal deformation error, a dynamic error, and the like.

Meanwhile, a technology for estimating an object's pose through vision recognition based on deep learning is being proposed. However, this technology involves a large amount of data for training and requires a person to label each piece of label data. Accordingly, preparing training data requires considerable human labor, and associated costs increase.

### SUMMARY OF THE INVENTION

To solve the above problems of vision recognition of the related art, the present invention is directed to providing a device and method for estimating a six degrees of freedom (6DoF) pose of an object on the basis of self-supervised learning with which self-supervised learning is performed using data generated in a virtual environment and thus human labor for labeling work in estimating 6DoF of a three-dimensional (3D) object can be reduced.

According to an aspect of the present invention, there is provided a method of estimating a pose of an object, the method including inputting a labeled source image and an unlabeled target image to a recognition model for generating training data, training the recognition model to generate object information of the unlabeled target image, determining the generated object information to be a pseudo label of the unlabeled target image, and training a pose estimation model for estimating a pose of an object by inputting the pseudo-labeled target image and the labeled source image to the pose estimation model.

The object information may include 6DoF and class information of the object.

The training of the recognition model may include causing a domain discriminator to predict domains of the labeled source image and the unlabeled target image and training the recognition model so that the domains of the image are not discriminated by the domain discriminator.

The training of the recognition model may include training the recognition model so that identical classes come closer to each other and different classes move away from each other through entropy clustering.

The training of the recognition model may include detecting outliers of the input data.

The labeled source image may be virtual data generated in a virtual environment, and the unlabeled target image may be an image generated in a real environment.

The recognition model may further output a distance from a center point of the object and scale and shape information of the object as the object information.

The recognition model may be a model based on transfer learning.

The training of the pose estimation model may be based on supervised learning.

The method may further include acquiring an image of a robot through a camera, inputting the image of the robot to the pose estimation model to estimate a pose of the robot, and controlling the robot on the basis of the estimated pose of the robot.

According to another aspect of the present invention, there is provided a device for estimating a pose of an object, the device including a training data generation module configured to receive a labeled source image and an unlabeled target image, train a recognition model using the received images, generate object information of the unlabeled target image, and determine the generated object information to be a pseudo label of the unlabeled target image, and a pose estimation model configured to receive the pseudo-labeled target image and the labeled source image and learn estimation of an object pose.

The object information may include 6DoF and class information of an object.

A domain discriminator may be caused to predict domains of the labeled source image and the unlabeled target image, and the recognition model is trained so that the domains of the images are not distinguished by the domain discriminator.

The recognition model may be trained so that identical classes come closer to each other and different classes move away from each other through entropy clustering.

Outliers of the input data may be detected to train the recognition model.

The labeled source image may be virtual data generated in a virtual environment, and the unlabeled target image may be an image generated in a real environment.

The recognition model may further output a distance from a center point of the object and scale and shape information of the object as the object information.

The recognition model may be a transfer learning-based model.

The pose estimation model may be trained on the basis of supervised learning.

According to another aspect of the present invention, there is provided a device for estimating a pose of an object, the device including a processor and a memory connected to the processor and configured to store commands. When the commands are executed by the processor, the commands cause the processor to perform operations of inputting a labeled source image and an unlabeled target image to a recognition model for generating training data, training the recognition model to generate object information of the unlabeled target image, determining the generated object information to be a pseudo label of the unlabeled target image, and training a pose estimation model for estimating a pose of an object by inputting the pseudo-labeled target image and the labeled source image to the pose estimation model.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a configuration of a device for estimating a six degree of freedom (6DoF) pose of an object on the basis of self-supervised learning according to an exemplary embodiment of the present invention;

FIG. 2 is a diagram illustrating a training data generation module of the device for estimating a 6DoF pose of an object on the basis of self-supervised learning according to the exemplary embodiment of the present invention;

FIG. 3 is a diagram illustrating operations of the training data generation module of the device for estimating a 6DoF pose of an object on the basis of self-supervised learning according to the exemplary embodiment of the present invention;

FIG. 4 is a flowchart illustrating a method of estimating a 6DoF pose of an object on the basis of self-supervised learning according to an exemplary embodiment of the present invention; and

FIG. 5 is a flowchart illustrating robot control based on a method of estimating a 6DoF pose of an object on the basis of self-supervised learning according to an exemplary embodiment of the present invention.

### DETAILED DESCRIPTION OF EXEMPLARY EMBODIMENTS

Hereinafter, exemplary embodiments of a device and method for estimating a six degree of freedom (6DoF) pose of an object on the basis of self-supervised learning according to the present invention will be described with reference to the accompanying drawings. In this process, the thicknesses of lines, the sizes of components, or the like shown in the drawings may be exaggerated for the clarity and convenience of description. Also, terms used herein are terms defined in consideration of functionality in the present invention and may vary depending on intentions of a user and operator or precedents. Therefore, these terms should be defined on the basis of the entire content of this specification.

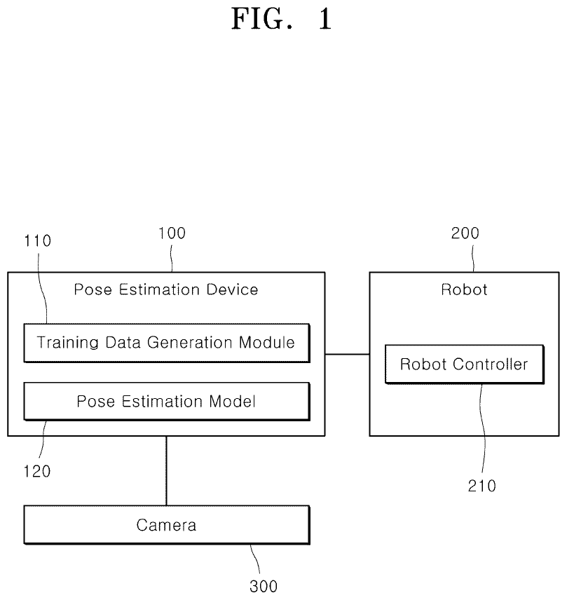

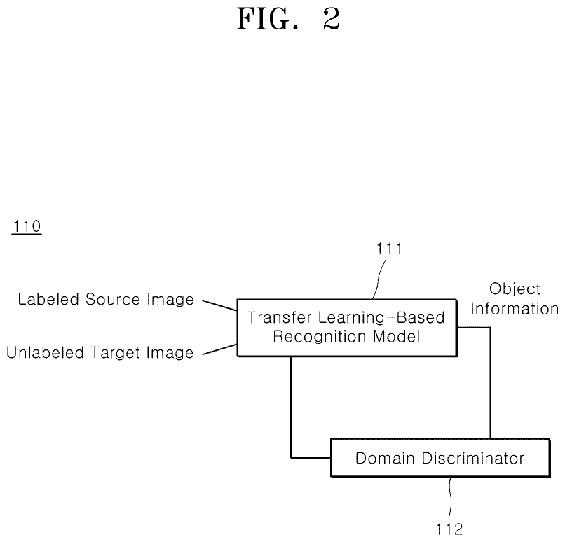

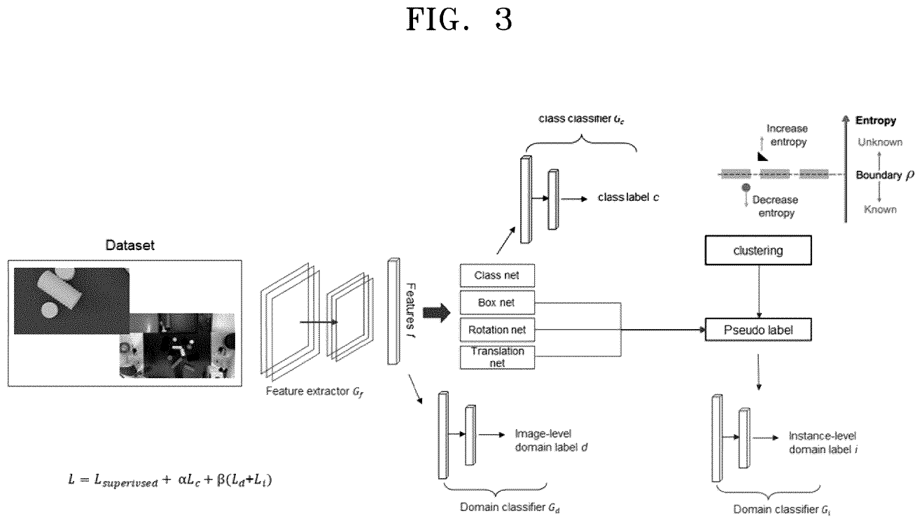

FIG. 1 is a block diagram illustrating a configuration of a device for estimating a 6DoF pose of an object on the basis of self-supervised learning according to an exemplary embodiment of the present invention. FIG. 2 is a diagram illustrating a training data generation module of the device for estimating a 6DoF pose of an object on the basis of self-supervised learning according to the exemplary embodiment of the present invention. FIG. 3 is a diagram illustrating operations of the training data generation module of the device for estimating a 6DoF pose of an object on the basis of self-supervised learning according to the exemplary embodiment of the present invention.

As shown in FIG. 1, a device 100 for estimating a 6DoF pose of an object on the basis of self-supervised learning according to the exemplary embodiment of the present invention may include a training data generation module 110 and a pose estimation model 120.

The training data generation module 110 may generate training data for training the pose estimation model 120.

As shown in FIG. 2, the training data generation module 110 may include a transfer learning-based recognition model 111 and a domain discriminator 112.

The transfer learning-based recognition model 111 receives a labeled source image and an unlabeled target image as inputs. Here, the labeled source image and the unlabeled target image may be input to the learning model as an input pair.

The labeled source image is data having object information (an output value of the learning model) of the image. The object information may include 6DoF of an object and a class of the object (object identification information) and may additionally include a distance from a center point and scale and shape information (e.g., a mesh and a boundary box). 6DoF includes 3DoF related to X, Y, and Z positions and information on rotation.

The labeled source image may correspond to virtual data generated in a virtual environment, and the unlabeled target image may correspond to an image generated in a real environment.

In other words, virtual data which is virtual environment data including a virtual image and three-dimensional (3D) information of a 3D virtual object may be generated in a virtual environment. Such virtual data may be automatically generated by a computing device or the like. When the data is generated, object information (6DoF and the like) of the virtual object is set, and thus the corresponding virtual data may be automatically labeled.

On the other hand, in the case of an image generated in a real environment, it is necessary to manually label object information of an object in the image. According to the present invention, manual labeling is not performed on an image generated in a real environment. Rather, the image is used as an unlabeled target image, and the training data generation module 110 performs pseudo-labeling on the image and uses the pseudo-labeled image as final training data. Accordingly, overall learning may be performed on the basis of self-supervised learning.

Meanwhile, a data augmentation technique may be applied to an unlabeled target image to increase the data, and the data may be learned.

Since this process corresponds to the transfer learning-based recognition model 111, the pair of the labeled source image and the unlabeled target image which have been described above is input to a pretrained recognition model, and the transfer learning-based recognition model 111 labels and learns the data set to recognize a 3D object.

As shown in FIG. 3, the transfer learning-based recognition model 111 may be a convolutional neural network (CNN)-based network. The transfer learning-based recognition model 111 extracts image-level features and instance-level features and learns a low-level feature map and a high-level feature map of a convolution block. Here, a data pipeline may be built for a dataset, and a transfer learning-based recognition model may be trained on the basis of the dataset (Training). Subsequently, an optimal performance model may be selected for the trained recognition model, verified to prevent overfitting, and tested to measure model performance (Inference). Since an associated general training process is well-known to those of ordinary skill in the art, detailed description thereof will be omitted.

For adversarial training in the process of learning object information, the domain discriminator 112 is caused to predict domains of the image generated in the virtual environment (source image) and the image generated in the real environment (target image), and learning is performed so that the domains of the images are not distinguished by the domain discriminator 112. In this way, the artificial neural network can extract a visual representative feature rather than a feature overfitting to a specific domain.

There is a distribution feature which is a feature representing a difference between data of a virtual environment and data of a real environment, that is, objects. It is possible to prevent performance degradation caused by such a distribution feature through the domain discriminator 112.

As shown in FIG. 3, in object information output from the learning model, there is a difference in a discriminative feature between object classes. A clustering loss function is defined to perform learning through entropy clustering so that identical classes come closer to each other and different classes move away from each other. Accordingly, learning of visual representations of instances is facilitated.

Further, in the case of objects such as factory parts, objects of the same type but of different sizes have smaller differences in discriminative features than objects of different types and of the same size. The problem of misrecognizing size can be solved by making a small discriminative feature difference big. In other words, larger errors occur in pose estimation at image edges due to distortion, and objects with similar shapes and features are inaccurately distinguished from each other in some cases. Here, accuracy in distinguishing between objects can be increased through a clustering loss function.

When learning is performed through this process, a prediction value for the unlabeled target image, that is, object information (6DoF, a class, and the like), is output from the transfer learning-based recognition model 111, and the output object information of the target image may be used as a label for the target image. In other words, data generated by the training data generation module 110 may include a pseudo-labeled target image.

The pose estimation model 120 may be trained on the basis of the foregoing pseudo-labeled target image and the labeled source image and then can learn and estimate pose information (6DoF) of a 3D object. Therefore, learning of the pose estimation model 120 may be supervised learning. In other words, learning of the pose estimation model 120 may be performed using labeled data and thus performed on the basis of supervised learning.

Meanwhile, according to some embodiments, the pose estimation model 120 and the transfer learning-based recognition model 111 may be learning models having the same structure. For example, the pose estimation model 120 may be a model based on a pretrained recognition model and may output object information (6DoF, a class, and the like) of an input image as an output value.

The 6DoF pose estimation device 100 including the trained pose estimation model 120 may be connected to a camera 300 for acquiring an image of a robot 200 and used for estimating a 6DoF pose of the robot 200. The estimated 6DoF pose of the robot 200 may be transmitted to a robot controller 210 and used for the robot controller 210 to control the robot 200.

The 6DoF pose estimation device 100 may be applied to factory automation based on robot control. Accordingly, it is possible to reduce the cost of factory automation, improve an inefficient internal process, and increase productivity. Also, when the accuracy of a model for predicting and generating 3D information of an object becomes 90% or more, real-time monitoring is possible in a robot-based manufacturing process.

Meanwhile, outlier detection may be applied to data used for generating training data or controlling an actual robot. For example, a moving average, a random sample consensus (RANSAC), an extended Kalman filter (EKF), or the like may be used for outlier detection. As an example, a prediction output may be generally processed as a signal using a low-pass filter or a filtering algorithm such as a moving average. However, a prediction result has little noise but includes a large outlier value. To address this problem, a RANSAC and an EKF may be used in combination. The EKF is used for removing quaternion noise which is similar to smoothing, and the RANSAC is used for detecting an outlier value of video data. Accordingly, to improve performance, it is necessary to detect an outlier value before smoothing. This is because considerable outliers disturb a corresponding output result during smoothing. In the case of determining a location or detecting an outlier value, unlike other methods of least squares, the RANSAC estimates a solution optimized to fitting parameters and a sample selected from all samples of the negative impacts of outlier values in randomly used data. Apart from rotation about the x, y, and z axes of previous and current frames, velocity and angular velocity may be used for removing outliers to track movement of a camera and object.

Information output from the 6DoF pose estimation device 100 of the present invention is 6DoF pose estimation information of an object and thus may be applied to a one-stage-based model (i.e., a configuration for directly outputting 6DoF of a robot). Accordingly, the information can be used for improving robot control through shorter inference time and fewer computing resources. Alternatively, in some embodiments, self-supervised learning may be performed on regions of interest (ROIs) of a two-stage-based model (i.e., a configuration for detecting the correspondence between key points and a two-dimensional (2D) image of a 3D object, estimating 6DoF on the basis of the correspondence, and then outputting the estimated 6DoF).

Meanwhile, according to the present invention, the configuration of the 6DoF pose estimation device 100 and a 6DoF pose estimation method to be described below may be implemented using a computing device.

The computing device may include at least one of a processor, a memory, an input interface device, an output interface device, a storage device, and a network interface. The components may be connected to a bus and communicate with each other. Also, the components may be connected not through a common bus but through individual interfaces or individual buses centering on the processor.

The processor may be implemented as various types, such as an application processor (AP), a central processing unit (CPU), a graphics processing unit (GPU), and the like, and may be a semiconductor device which executes commands stored in the memory or the storage device. The processor may execute program commands stored in at least one of the memory and the storage device. The processor may be configured to implement the foregoing functions and methods to be described below. For example, the processor may be implemented to perform functions of a training data generation module and a pose estimation model.

The memory and the storage device may include various forms of volatile or non-volatile storage media. For example, the memory may include a read-only memory (ROM) and a random access memory (RAM). In an exemplary embodiment of the present disclosure, the memory may be present in or outside the processor, and the memory may be connected to the processor using various known methods.

The input interface device is configured to provide data to the processor, and the output interface device is configured to output data (object information and the like) from the processor.

The network interface device may transmit or receive signals to or from another device (e.g., a robot) through a wired network or a wireless network.

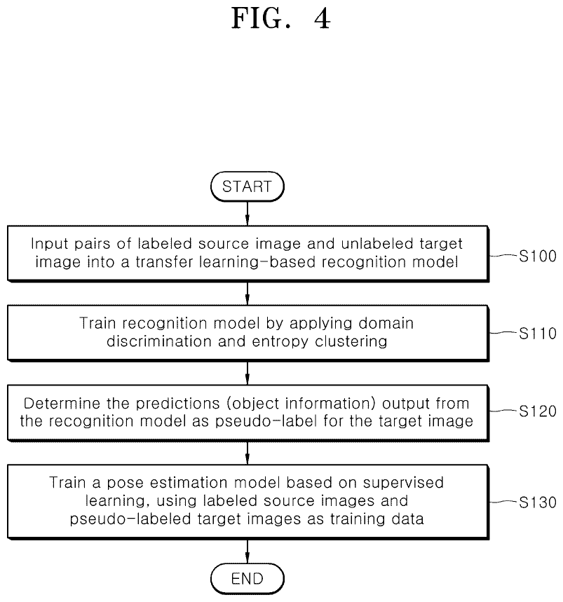

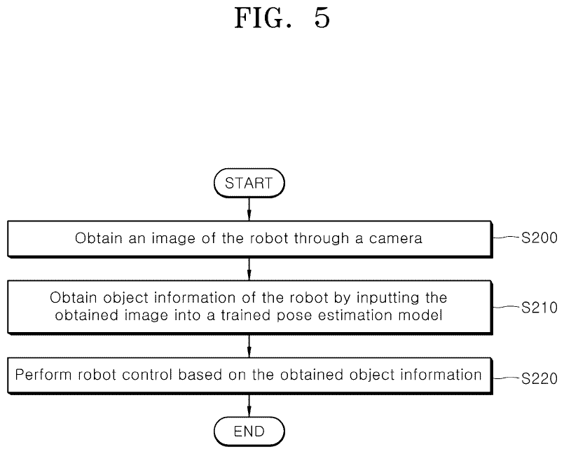

FIG. 4 is a flowchart illustrating a method of estimating a 6DoF pose of an object on the basis of self-supervised learning according to an exemplary embodiment of the present invention, and FIG. 5 is a flowchart illustrating robot control based on a method of estimating a 6DoF pose of an object on the basis of self-supervised learning according to an exemplary embodiment of the present invention.

As shown in FIG. 4, according to the method of estimating a 6DoF pose of an object on the basis of self-supervised learning, a pair of a labeled source image and an unlabeled target image is input to a transfer learning-based recognition model (S100). Here, the labeled source image may correspond to virtual data generated in a virtual environment, and the unlabeled target image may correspond to an image generated in a real environment.

After that, the recognition model is trained through domain discrimination and entropy clustering (S110). In other words, a domain discriminator may be used for predicting domains of the image generated in the virtual environment (source image) and the image generated in the real environment (target image), and training is performed so that the domains of the images are not distinguished by the domain discriminator 112. Also, entropy clustering may be applied to clarify distinguishment between classes.

Subsequently, it is determined that a prediction value (object information) output from the recognition model is a pseudo label of the target image (S120). In other words, the object information (6DoF, a class, or the like) may be output from the transfer learning-based recognition model, and the output object information of the target image may be used as a label for the target image.

Subsequently, a pose estimation model is trained on the basis of supervised learning using the labeled source image and the pseudo-labeled target image as training data (S130). The pose estimation model may be trained on the basis of the pseudo-labeled target image and the labeled source image described above, and thus the pose estimation model may learn and estimate pose information (6DoF) of a 3D object. Accordingly, training of the pose estimation model 120 may be performed on the basis of supervised learning.

Robot control may be performed on the basis of the trained pose estimation model as follows.

First, an image of a robot is acquired through a camera (S200). Subsequently, object information of the robot is acquired by inputting the acquired image to the trained pose estimation model (S210). In other words, pose information (6DoF) of the robot may be estimated from the image through the trained pose estimation model.

Subsequently, robot control is performed on the basis of the acquired object information (S220). In this way, precise control over the robot and the like can be achieved. Accordingly, it is possible to reduce the cost of factory automation, improve an inefficient internal process, and increase productivity.

According to a device and method for estimating a 6DoF pose of an object on the basis of self-supervised learning according to the present invention, training is performed on the basis of self-supervised learning using data generated in a virtual environment and data generated in a real environment in combination. Accordingly, it is possible to reduce the cost required for acquiring a huge labeled data set, reduce human labor time for labeling, and automatically generate labels, leading to efficient machine learning.

According to a device and method for estimating a 6DoF pose of an object on the basis of self-supervised learning according to the present invention, unlabeled data is used, but pseudo labels are generated so that an overall model may perform supervised learning. Accordingly, analysis performance of vision recognition is improved, and a 3D object can be accurately recognized.

With a device and method for estimating a 6DoF pose of an object on the basis of self-supervised learning according to the present invention, object information including 6DoF information of a 3D object can be acquired. Accordingly, it is possible to identify shapes and functional abnormalities which are difficult to process with machine vision according to the related art, through image analysis based on deep learning.

With a device and method for estimating a 6DoF pose of an object on the basis of self-supervised learning according to the present invention, such a 3D object recognition device and method can be applied to a robot-based factory automation process, and it is possible to increase efficiency in factory automation.

Although the present invention has been described with reference to exemplary embodiments shown in the drawings, the embodiments are illustrative, and those of ordinary skill in the art should understand that various modifications and other embodiments equivalent thereto can be made from the embodiments. Therefore, the technical scope of the present invention should be determined from the following claims.

What is claimed is:

1. A method of estimating a pose of an object, the method comprising:
inputting a labeled source image and an unlabeled target image to a recognition model for generating training data;
training the recognition model to generate object information of the unlabeled target image;
determining the generated object information to be a pseudo label of the unlabeled target image; and
training a pose estimation model for estimating a pose of an object by inputting the pseudo-labeled target image and the labeled source image to the pose estimation model.

2. The method of claim 1, wherein the object information includes six degrees of freedom (6DoF) and class information of the object.

3. The method of claim 2, wherein the training of the recognition model comprises causing a domain discriminator to predict domains of the labeled source image and the unlabeled target image and training the recognition model so that the domains of the images are not distinguished by the domain discriminator.

4. The method of claim 2, wherein the training of the recognition model comprises training the recognition model so that identical classes come closer to each other and different classes move away from each other through entropy clustering.

5. The method of claim 2, wherein the training of the recognition model comprises detecting outliers of the input data.

6. The method of claim 1, wherein the labeled source image is virtual data generated in a virtual environment, and
the unlabeled target image is an image generated in a real environment.

7. The method of claim 1, wherein the recognition model further outputs a distance from a center point of the object and scale and shape information of the object as the object information.

8. The method of claim 1, wherein the recognition model is a transfer learning-based model.

9. The method of claim 1, wherein the training of the pose estimation model is performed on the basis of supervised learning.

10. The device of claim 1, further comprising:
acquiring an image of a robot through a camera;
inputting the image of the robot to the pose estimation model to estimate a pose of the robot; and
controlling the robot on the basis of the estimated pose of the robot.

11. A device for estimating a pose of an object, the device comprising:
a training data generation module configured to receive a labeled source image and an unlabeled target image, train a recognition model using the received images, generate object information of the unlabeled target image, and determine the generated object information to be a pseudo label of the unlabeled target image; and
a pose estimation model configured to receive the pseudo-labeled target image and the labeled source image and learn estimation of an object pose.

12. The device of claim 11, wherein the object information includes six degrees of freedom (6DoF) and class information of the object.

13. The device of claim 12, wherein a domain discriminator is caused to predict domains of the labeled source image and the unlabeled target image, and
the recognition module is trained so that the domains of the images are not distinguished by the domain discriminator.

14. The device of claim 12, wherein the recognition model is trained so that identical classes come closer to each other and different classes move away from each other through entropy clustering.

15. The device of claim 12, wherein outliers of the input data are detected to train the recognition model.

16. The device of claim 11, wherein the labeled source image is virtual data generated in a virtual environment, and
the unlabeled target image is an image generated in a real environment.

17. The device of claim 11, wherein the recognition model further outputs a distance from a center point of the object and scale and shape information of the object as the object information.

18. The device of claim 11, wherein the recognition model is a transfer learning-based model.

19. The device of claim 11, wherein the pose estimation model is trained on the basis of supervised learning.

20. A device for estimating a pose of an object, the device comprising:
a processor; and
a memory connected to the processor and configured to store commands,
wherein, when the commands are executed by the processor, the commands cause the processor to perform operations of:
inputting a labeled source image and an unlabeled target image to a recognition model for generating training data;
training the recognition model to generate object information of the unlabeled target image;
determining the generated object information to be a pseudo label of the unlabeled target image; and
training a pose estimation model for estimating a pose of an object by inputting the pseudo-labeled target image and the labeled source image to the pose estimation model.
